(19) United States
(12) Patent Application Publication
(10) Pub. No.: US 2009/0225402 A1
(43) Pub. Date: Sep. 10, 2009

(54) ARTICLE COMPRISING A WIDEBAND OPTICAL AMPLIFIER WITH A WIDE DYNAMIC RANGE

(75) Inventors: Paul Francis Wysocki, Flemington, NJ (US); Mitchell Steven Wlodawski, West Caldwell, NJ (US)

Correspondence Address: MAYER & WILLIAMS PC, 251 NORTH AVENUE WEST, 2ND FLOOR, WESTFIELD, NJ, 07090, US

(73) Assignee: UNOPSYS L.L.C., West Caldwell, NJ (US)

(21) Appl. No.: 12/246,416

(22) Filed: Oct. 6, 2008

Related U.S. Application Data
(63) Continuation of application No. 11/146,899, filed on Jun. 7, 2005, now abandoned.
(60) Provisional application No. 60/577,553, filed on Jun. 7, 2004.

(51) Int. Cl. H01S 3/00; H04B 10/12; H01S 3/09

(52) U.S. Cl. 359/337.4; 359/341.5; 359/337.1; 359/341.3

(57) ABSTRACT

A multi-channel optical amplifier arrangement operating over a particular bandwidth is provided. The amplifier arrangement includes at least one optical amplifier stage that includes a rare-earth doped optical waveguide, at least one pump source for supplying optical pump energy to the doped optical waveguide, and at least one coupler for coupling the optical pump energy to the doped optical waveguide. The amplifier arrangement also includes a dynamic range enhancer (DRE) having an input and an output and a plurality of distinct optical paths each selectively coupling the input to the output. At least two of the optical paths produce different gain spectra across the particular operating bandwidth. The DRE further includes an optical path selector for selecting any optical path from among the plurality of optical paths such that for all channels in the particular bandwidth the selected path optically couples the input to the output of the DRE. An input or output of the optical amplifier stage is optically coupled to the output or the input, respectively, of the DRE.

### STATEMENT OF RELATED APPLICATIONS

This is a continuation of U.S. patent application Ser. No. 11/146,899, filed Jun. 7, 2005, entitled “Article Comprising A Wideband Optical Amplifier With A Wide Dynamic Range,” which claims priority to U.S. Provisional Patent Application No. 60/577,553, also entitled “Article Comprising A Wideband Optical Amplifier With A Wide Dynamic Range,” filed on Jun. 7, 2004. Both of the prior applications are incorporated by reference herein in their entireties.

### FIELD OF THE INVENTION

The present invention relates to amplification in optical fiber networks and more particularly to the design of fiber-optic amplifiers with a wide dynamic range of operation.

### BACKGROUND OF THE INVENTION

In current optical communication systems, signals are transmitted long distance using multiple wavelength of light passing through optical fibers. Each optical carrier wavelength can be encoded with a unique set of information. The broader the optical bandwidth of the transmission system, the more information can be transmitted using more wavelength-division multiplexed (WDM) signals. Such WDM optical systems use optical fibers, which produce some level of optical loss, typically 0.15-0.3 dB/km. Additionally, components used in these systems to perform functions such as dispersion compensation or dynamic equalization add optical loss. In order to overcome these losses and maintain the optical signal to noise ratio (OSNR) of each channel, optical amplification is required periodically. Such optical amplification must be broadband, at least as broadband as the wavelength range of signals to be transmitted and its gain must be close to constant for all signal wavelengths (gain flat) so that all signals experience nearly the same gain. Additionally, the amplification must not add much noise to the amplified signal, as represented by a low amplifier noise figure (NF).

Unfortunately, the gain of most optical gain media is not flat across a wide range of optical wavelengths. However, flatness can be achieved using an optical filter, which is a device that creates a predetermined wavelength-dependent optical loss to perfectly compensate for any gain flatness error. Such a filter is typically placed within each amplifier to achieve gain flatness to some tolerance level. For most optical gain media, such a filter makes the gain flat at only one particular gain level. So, a different filter is needed if the optical gain or output power level of the amplifier changes.

While optical gain is possible in many different gain media, in most current deployed optically amplified communication systems, the gain medium consists of erbium ions doped into a silica-based fiber. Such erbium-doped fibers (EDF), when provided with sufficient optical pump radiation from available pump diodes, can provide efficient low noise amplification at the low loss window of optical transmission fibers, namely near 1550 nm. EDFs can produce gain across a 40 nm window from 1525-1565 nm (called the C-band) or can be designed differently to produce gain from 1565-1605 nm (called the L-band). In both bands, the gain is not adequately flat for most WDM optical communications systems and the shape of the gain varies with operating condition.

In most cases, optical systems contain a wide range of optical span lengths with a range of component losses, leading to an even wider range of optical losses. These must be compensated by an EDFA that achieves a wide range of optical gain levels. Such variation can be accommodated in several ways. The most direct way is to design a different custom amplifier, typically an EDFA, that is gain flat, produces a low NF and adequate output power for each prescribed operating point. Such an approach meets performance needs, but is expensive and requires a large inventory of EDFAs designed to different specification (often called design codes). A second approach is to add loss to every span to make all span losses equal, hence requiring all amplifiers to be the same. Such an approach unnecessarily and often severely degrades the NF and/or power output of the EDFAs and the OSNR at the end of the system.

The third and prevailing approach to accommodate gain variation in optical amplifiers is to add a variable loss element, typically called a variable optical attenuator (VOA) within each amplifier at a location where it does not unnecessarily penalize the NF or power output. Such VOAs are commercially available and have been made using a variety of optical technology platforms. Using a VOA within an EDFA, the operating gain can be adjusted by changing both the pump power used and the loss setting of the VOA so that a low NF and gain flatness can be maintained for a range of gain levels and output powers. The range of gain levels (the dynamic range) that can be accommodated while still maintaining adequate performance (including a low NF, gain flatness, and required output power) by using such a VOA approach is typically less than 15 dB. Additionally, some of this dynamic range is often used to adjust for changes as the system ages, so that the useful dynamic range to adjust for link variations is typically less than 10 dB.

The usable dynamic range of an EDFA is often further reduced in order to accommodate a range of lossy component modules, known as dispersion compensation modules (DCMs). The loss of such modules, and the need for their use, depends on the bit rate of the system, the length of the span fibers and the type of transmission fiber used. Depending on the system design, as little as 3 dB of amplifier dynamic range might be available to accommodate span length variation, even when a VOA is included in each amplifier. Needless to say, it would be desirable to produce amplifiers, particularly EDFAs, which can accommodate system aging, DCM modules and a wide range of span lengths, while still maintaining a low NF and flat gain spectrum.

### SUMMARY OF THE INVENTION

The present invention is embodied in an optical fiber amplifier which is able to produce a dynamic range of operation far exceeded any optical fiber amplifier previously described. Such a device necessarily includes one or multiple stages of optical amplification with an optical fiber gain medium and a properly selected source of optical pump radiation coupled into the fiber in order to produce amplification. The device described herein also necessarily contains a pair of optical switches which define a region within the amplifier where two or more alternate paths can be selected for propagating signals through a portion of the amplifier. The alternate paths may be selected in order to allow operation over a different range of gain levels.

According to one aspect of the invention, the alternate paths in the amplifier contain only passive optical filtering elements that filter the amplifier to flatness in different operating ranges. According to another aspect of the invention, one or more of the alternate paths contain a length or different lengths of unpumped gain fiber. According to yet another aspect of the invention, one or more of the alternate paths contain a pumped gain fiber of some length. The pump power for this or these fibers may be supplied by independent pump sources, shared pump sources or pump sources shared with the rest of the amplifier.

According to yet another aspect of the invention, the amplifier design may also include a VOA, or multiple VOAs in the multiple path section to allow an even greater range of operation. According to yet another aspect of the invention, the switched multipath region of the amplifier can be advantageously placed between two stages of amplification to minimize any performance penalties. According to another aspect, the switched section of the amplifier can be placed at the output of the amplifier to achieve a range of output power levels.

According to another aspect of the invention, the amplifier is an EDFA operating in the C-band or L-band.

In accordance with one aspect of the invention, a multi-channel optical amplifier arrangement operating over a particular bandwidth is provided. The amplifier arrangement includes at least one optical amplifier stage that includes a rare-earth doped optical waveguide, at least one pump source for supplying optical pump energy to the doped optical waveguide, and at least one coupler for coupling the optical pump energy to the doped optical waveguide. The amplifier arrangement also includes a dynamic range enhancer (DRE) having an input and an output and a plurality of distinct optical paths each selectively coupling the input to the output. At least two of the optical paths produce different gain spectra across the particular operating bandwidth. The DRE further includes an optical path selector for selecting any optical path from among the plurality of optical paths such that for all channels in the particular bandwidth the selected path optically couples the input to the output of the DRE. An input or output of the optical amplifier stage is optically coupled to the output or the input, respectively, of the DRE.

According to another aspect of the invention, at least one of the optical paths is doped with a rare-earth doped optical element

According to another aspect of the invention, the DRE is a modular unit selectively removable from and optically couple-able to the optical amplifier stage.

According to another aspect of the invention, when each distinct path of the DRE is selected and an operating condition of the amplifier arrangement is adjusted to produce a most nearly flat gain condition, the magnitude of the gain achieved is different for at least two of the distinct paths, wherein the most nearly flat gain condition is defined as the condition that achieves the minimum value of the difference between the maximum gain and minimum gain for any wavelength within the particular bandwidth.

According to another aspect of the invention, the DRE is a modular unit selectively removable from and optically couplable to the optical amplifier stage.

According to another aspect of the invention, the plurality of distinct optical paths comprise N optical paths, N being an integer equal to or greater than 2, and the optical path selector includes first and second 1×N optical switches for selectively switching among the N optical paths.

According to another aspect of the invention, at least one optical amplifier stage includes at least first and second optical amplifier stages.

According to another aspect of the invention, the input of the DRE is coupled to an output of the first optical amplifier stage and the output of the DRE is coupled to the input of the second optical amplifier stage.

According to another aspect of the invention, the DRE is located at a midstage access (MSA) connection port to the optical amplifier arrangement, the MSA connection port being located between any two optical amplifier stages.

According to another aspect of the invention, the optical amplifier arrangement further comprises a variable optical attenuator optically coupled to at least the optical amplifier stage or the DRE.

According to another aspect of the invention, the optical amplifier arrangement further comprises at least one pump source for supplying optical pump energy to the rare-earth doped optical path of the DRE.

According to another aspect of the invention, the doped optical waveguide is a doped optical fiber.

According to another aspect of the invention, the doped optical waveguide is a doped planar waveguide.

According to another aspect of the invention, the doped optical waveguide is doped with erbium.

According to another aspect of the invention, each of the optical paths comprises an optical fiber.

According to another aspect of the invention, each of the optical paths comprises an optical planar waveguide.

According to another aspect of the invention, each of the plurality of optical paths is doped with a rare-earth optical element.

According to another aspect of the invention, (N−1) of the N optical paths are doped with a rare-earth optical element.

According to another aspect of the invention, each of the plurality of optical paths provides a most nearly flat level of gain across an operating band of the optical amplifier stage at a common rare-earth ion inversion level.

According to another aspect of the invention, the optical amplifier arrangement further comprises at least one pump source for supplying optical pump energy to at least two of the rare-earth doped optical paths.

According to another aspect of the invention, at least one of the optical paths has at least one element located therein selected from the group that includes an optical filter, a passive optical component, and an adjustable loss element.

In accordance with another aspect of the invention, an apparatus for extending the dynamic range of a multi-channel optical amplifier operating over a particular bandwidth is provided. The apparatus includes an input, an output, and a plurality of distinct optical paths each selectively coupling the input to the output. At least two of the optical paths produce different gain spectra across the particular operating bandwidth. At least one of the optical paths includes a rare-earth doped optical element. The apparatus also includes an optical path selector for selecting any optical path from among the plurality of optical paths such that for all channels in the particular bandwidth the selected path optically couples the input to the output. An input or output of the optical amplifier stage is optically coupled to the output or the input, respectively, of the DRE.

In accordance with another aspect of the invention, a method is provided for extending the dynamic range of a multi-channel optical amplifier operating over a particular bandwidth, wherein the dynamic range is defined as the range of gains over which a most nearly flat gain spectrum is achieved. The method begins by receiving an optical signal at an input and directing the optical signal from the input to a selected one of a plurality of distinct optical paths each selectively optically coupling all channels in the particular bandwidth from the input to an output. At least two of the optical paths produce different gain spectra across the particular operating bandwidth. At least one of the optical paths includes a rare-earth doped optical element. Each of the optical paths has the characteristic that produces, when coupled with the optical amplifier stage, a combined gain spectrum of the optical amplifier over the particular bandwidth that would be most nearly flat at a different gain. An input or output of a stage of the optical amplifier is optically coupled to the output or the input, respectively.

### BRIEF DESCRIPTION OF THE DRAWINGS

FIG. 1 shows the base modeling parameters for an exemplary erbium doped fiber (EDF), which in this particular example is a high aluminum codoped silicate fiber.

FIG. 2 shows the gain per unit length as a function of average erbium ion inversion for a fiber with the modeling parameters shown in FIG. 1 operating in a regime typical for a C-band EDFA.

FIG. 3 shows the gain per unit length as a function of average erbium ion inversion for a fiber with the modeling parameters shown in FIG. 1 operating in a regime typical for a L-band EDFA.

FIG. 4 shows an exemplary point-to-point optical transmission system in which the EDFAs of the present invention may be employed.

FIG. 5 shows an exemplary ring optical transmission system n which the EDFAs of the present invention may be employed.

FIG. 6 shows a conventional wide-dynamic range EDFA using a VOA to adjust the operating flat gain range.

FIG. 7 shows a conventional narrow dynamic range EDFA that does not employ a DCM.

FIG. 8 shows the spectral shape of a filter required by the EDFA depicted in FIG. 6 operating with 26 dB gain in the C-band.

FIG. 9 shows the worst channel NF as a function of midstage loss for the EDFA of FIG. 8.

FIG. 10 shows one embodiment of a wide-dynamic range EDFA arrangement constructed in accordance with the present invention, which uses a multiple of differently designed EDFAs arranged in a parallel configuration and which are to provide a flat gain in different operating gain ranges.

FIG. 11 shows an alternative embodiment of the EDFA arrangement depicted in FIG. 10, which employs additional switches to reroute mid-stage access when the individual EDFAs are switched.

FIG. 12 shows one embodiment of a dynamic range enhancer (DRE) constructed in accordance with the present invention.

FIG. 13 shows the DRE of FIG. 12 used in an EDFA that does not incorporate a VOA.

FIG. 14 shows the DRE of FIG. 12 located at the midstage access point of an EDFA.

FIG. 15 shows the DRE of FIG. 12 used in an EDFA that does incorporate a VOA to achieve a wider dynamic range.

FIG. 16 shows the gain shape ripple per dB of gain change produced in tone particular example when the DRE does not employ a filter.

FIG. 17 shows an alternative embodiment of the DRE that includes optical filters within each of the optical paths through the DRE.

FIG. 18 shows another embodiment of the DRE in accordance with present invention, which includes multiple optical pumps that supply each of the optical paths within the DRE with pump energy.

FIG. 19 shows another embodiment of the DRE in accordance with the present invention, which includes a single optical pump that supplies pump energy to all of the optical paths through the DRE.

FIG. 20 compares the NF for the EDFA discussed in connection with FIG. 9 with and without a DRE.

FIG. 21 compares the VOA loss setting for the EDFA discussed in connection with FIG. 9 with and without a DRE.

### DETAILED DESCRIPTION

In early optically amplified communication systems, erbium-doped fiber amplifiers (EDFA) were used to amplify single channels at a particular optical wavelength in the C-band. It soon became apparent that the gain bandwidth of such EDFAs allowed them to be used to amplify multiple signals simultaneously. In such an application the optical amplifier is referred to as multi-channel optical amplifier. This approach is known as wavelength-division multiplexing (WDM) and it is a standard approach in optical transmission systems for most applications, for many system lengths, span lengths and bit rates. The gain spectrum of an EDFA depends on operating condition. In the first approximation, the spectrum can be mathematically computed using the following formula:

G(λ,Īnv,l)=[(g*(λ)+α(λ))Īnv−α(λ)−BG(λ)]l−L(λ) (1)

Where g*(λ) and α(λ) are, respectively, the fully-inverted gain and the uninverted absorption coefficients of the erbium ions in the EDF per unit length, Īnv is the average ion inversion along the fiber length l, BG(λ) is the background loss of the EDF per unit length and L(λ) is the sum of all the passive optical loses of all components and all attachment methods used in the EDFA. This includes any fixed or dynamic filters and VOAs located within the EDFA structure. As used herein the term “gain” refers to either a positive or negative value (in dB) denoting an increase or decrease in signal level, respectively.

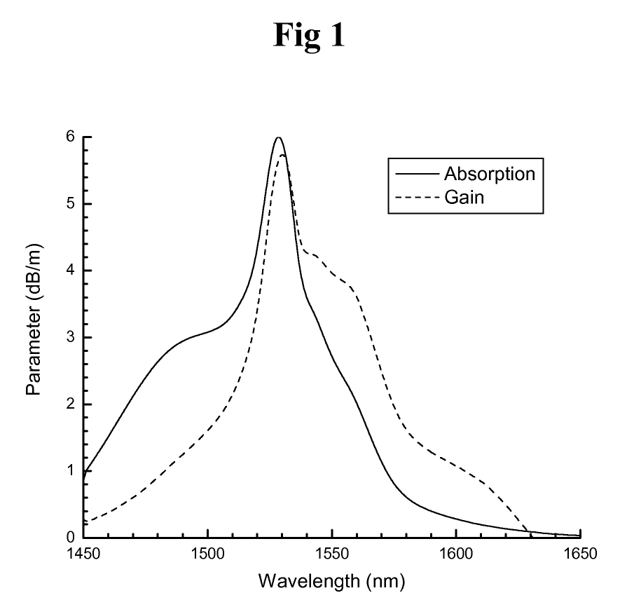

Equation 1 is generally applicable to any EDFA, no matter how many stages it has and how complex it is, as long as the length used is the total length of all EDF in the EDFA, the average inversion value used is the average across all segments of EDF, the component loss L(λ) is the sum for all passive components in the signal path and the fiber parameters BG(λ), g*(λ) and α(λ) are the same for all EDF segments (the same EDF is used in all segments). The base parameters g*(λ) and α(λ) for a typical EDF are shown in FIG. 1. This fiber is a high-aluminum silicate fiber, a composition typically used to produce a flat gain spectrum. BG(λ) is typically a low magnitude and nearly wavelength independent quantity that will be neglected here for ease of discussion.

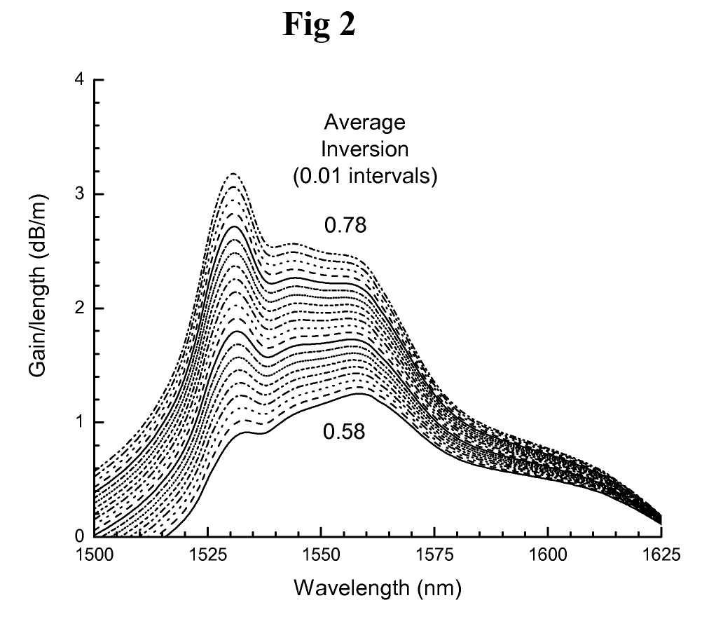

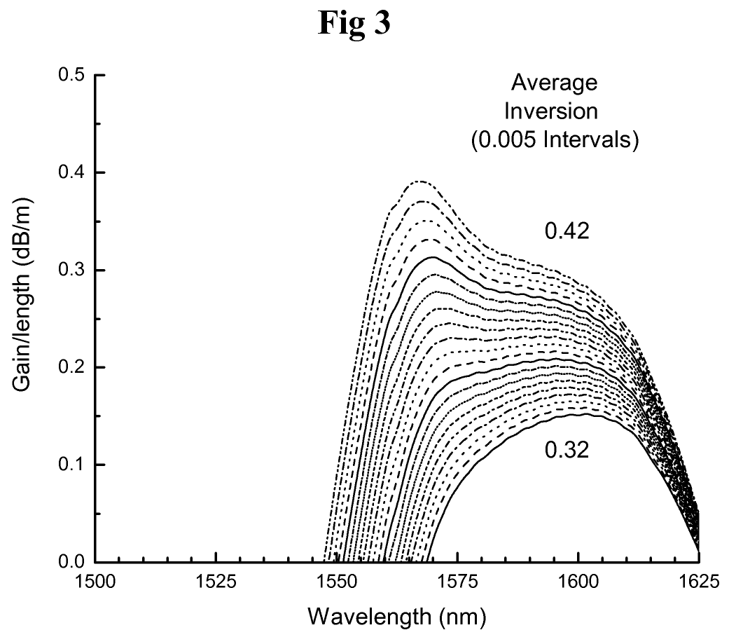

Eq. 1 can be rewritten (neglecting background loss) in a more illustrative form:

[G(λ,Īnv,l)+L(λ)]/l=(g*(λ)+α(λ)) I̅n̅v̅−α(λ) (2)

where the left side of the equation represents the EDF gain per length needed to achieve the measured gain G(λ,Īnv,l) with the known component losses L(λ). The average inversion of the erbium ions and the effective gain per unit length of the EDFA are linearly related. For the fiber represented by FIG. 1, a plot of the left side of this expression vs. average inversion is shown in FIG. 2 for average inversion levels from 0.58 to 0.78, typically useful values for EDFA operation in the C-band. Similarly, a plot for average inversion levels ranging from 0.32 to 0.42, typical values for EDFA operation in the L-band, is shown in FIG. 3. For the C-band, operation near 0.66 average inversion produces the flattest spectrum, while, for the L-band, 0.375 average inversion produces the best flatness. Any EDFA at any gain level can achieve any of these spectra, by simply choosing the length such that FIG. 2 or 3, when multiplied by the length, produces the desired gain.

The above mathematics illustrates an often unappreciated feature concerning optical amplification in EDFAs; namely, that if a given EDFA achieves a given gain and contains a known amount of component losses and EDF length, the spectrum is always the same. This statement is an excellent approximation, though not perfect for most EDFAs. The gain spectrum shape is a direct indicator of the average ion inversion, no matter how pump power is provided (e.g., from any direction or any pump wavelength), how much pump energy is needed to achieve the gain or how the component losses or fiber length are rearranged. This law holds in the approximation that all erbium ions are optically identical, a condition that is called homogeneous broadening. The approximation is a good one and is generally accepted for EDFs, with only minor corrections made for spectrum inhomogeneity. The mathematics also is valid for other gain media that are approximately homogeneous. For example other rare-earth doped fibers, such as ytterbium-doped fibers, which produces amplification near 1 □m, or neodymium-doped fibers, that amplify near 1300 nm or 1064 nm, may also be adequately described by this approach. Even in other gain media, such as semiconductor optical amplifiers, Eqs. 1 and 2 are often approximately valid. Hence, the mathematics and approach revealed here apply to a wide range of optical amplifiers when applied in optical communication systems.

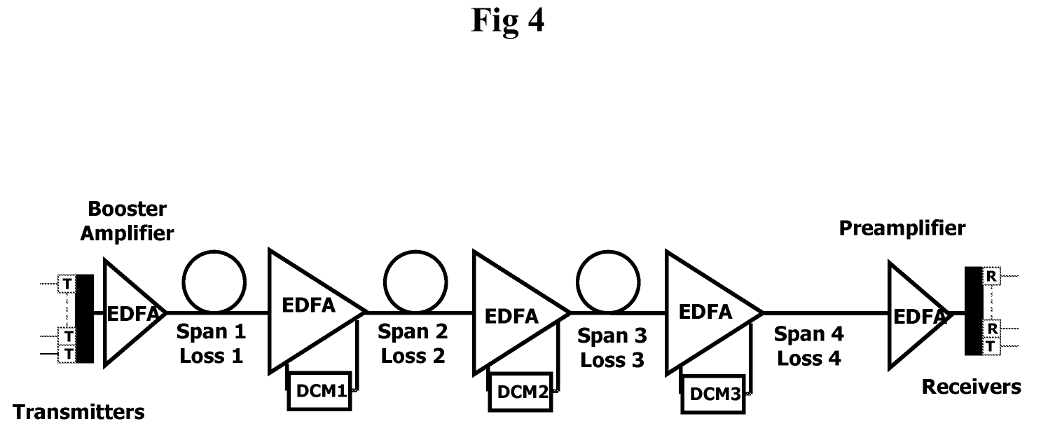

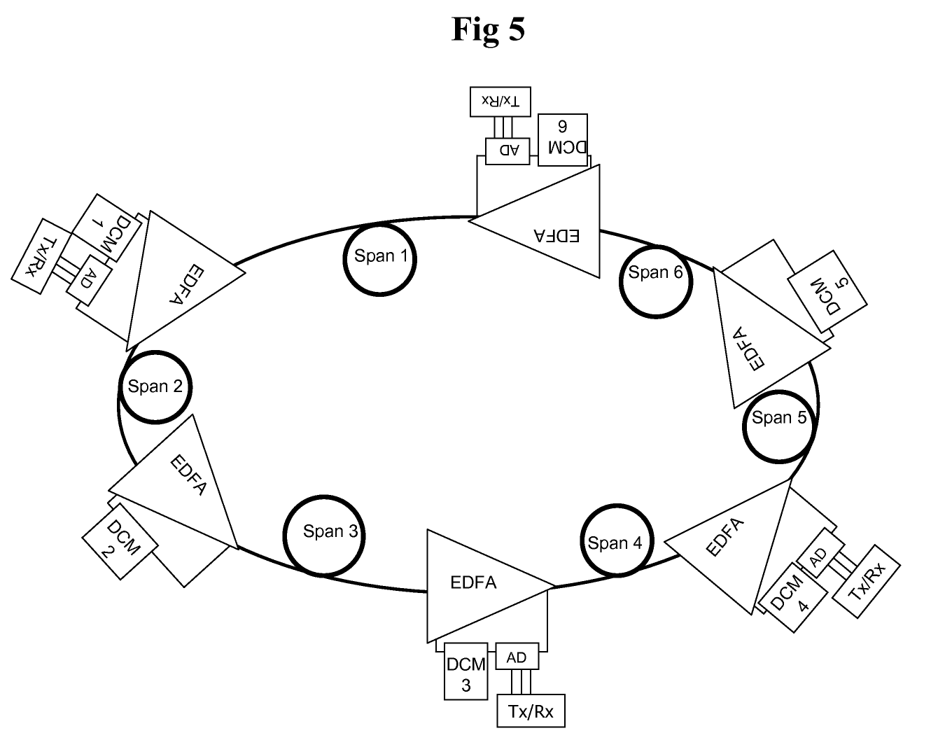

Optical communications systems are often designed with a wide range of span losses between optical regeneration sites (amplifiers) and also use a range of different transmission fiber types with different losses and different characteristics. Practical issues do not often allow the amplifiers to be evenly spaced or the system to operate with only a single fiber type. One characteristic of an optical fiber is its optical chromatic dispersion, which is a measure of the difference in propagation speeds of light in the fibers as a function of wavelength. Systems are often designed containing devices that compensate for dispersion, so that all wavelengths contained in a signal arrive at the receiver at the same time. These dispersion-compensating modules (DCMs) create optical loss and are often added within the system inside the optical amplifier or between stages of amplification, a design decision that is known to advantageously minimize the accumulation of optical noise. An exemplary point-to-point transmission system using EDFAs is illustrated in FIG. 4. In this case, many signals are combined and transmitted through a series of EDFAs and transmission span fibers to a common end location where they are separated and sent to receivers. Similarly, an exemplary ring type optical transmission system is shown in FIG. 5. In this configuration, signals at different wavelengths are added to the ring and dropped from the ring at several locations (called nodes). The net result is a variety of total path lengths and fiber types experienced by different signals. In both types of systems, different types of transmission fibers may be used. Typical varieties include SMF-28, a standard single-mode optical fiber made by Corning Inc, and True-Wave fiber, another fiber made by OFS-Fitel. The distance between amplifiers and hence the fiber loss may vary from span to span, as may the dispersion present. So each span may require a different DCM type to perfectly compensate for the dispersion present. In order to reduce the number of EDFA custom design codes, it is necessary for an EDFA to produce a wide range of optical gain levels (i.e., dynamic range) over which the spectrum is most nearly flat, while still maintaining low NF characteristics and a high output power. It would even be more advantageous if the EDFA code could be the same in both a ring and a point-to-point architecture, and could be used as well for the preamplifier and booster amplifier shown in FIG. 4. To date, this goal of a universal wide-dynamic range EDFA, has not been achieved in optical network architectures.

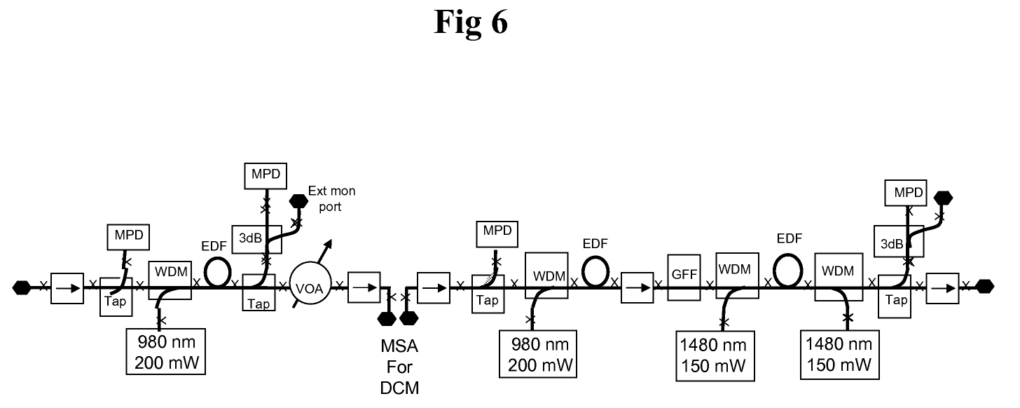

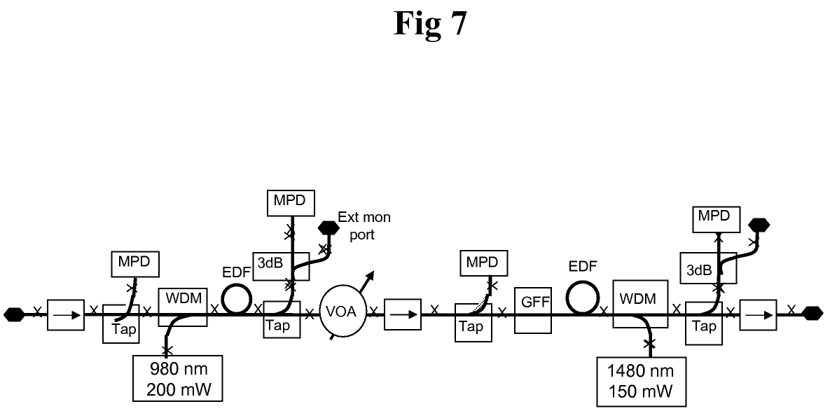

Currently, a wide dynamic range is achieved in an EDFA by inserting a VOA within the amplifier and varying the passive loss of the VOA to accommodate variations in span and other component losses. An exemplary wide-dynamic range EDFA that accommodates a DCM at a midstage access point (MSA) according to the currently favored approach is shown in FIG. 6. Similarly, using the current approach, an exemplary simpler wide-dynamic range EDFA that does not accommodate DCMs at an MSA is shown in FIG. 7. In these diagrams, optical taps are shown and are used to send light to monitor photodiodes to actively monitor EDFA performance. Optical isolators (indicated by boxes with arrows) are used to eliminate backward traveling reflected signals and backward-traveling amplified spontaneous emission (ASE), while WDMs are used to couple pump light into each stage while passing signal through the chain of amplifiers.

Eq. 2 can be rewritten to reflect the presence of the VOA and the optical transmission span. In particular, treating the entire link, from the beginning of an EDFA to the end of the following transmission fiber span as a single entity, we may write:

$${G}_{span} ( λ , \overline{I} nv , l ) = [ ( g ⋆ ( λ ) + α ( λ ) ) \overline{I} nv - α ( λ ) ] l - {L}_{pass} ( λ ) - {L}_{filt} ( λ ) - {L}_{DCM} ( λ ) - {L}_{VOA} ( λ ) - {L}_{span} ( λ ) \approx 0 \qquad ( 3 )$$

where Lₚₐₛₛ(λ), L_{filt}(λ), L_{VOA}(λ), L_{DCM}(λ) and Lₛₚₐₙ(λ) are the losses of all passive components in the EDFA (not including VOA, filter and DCM), the loss of any filtering element (wavelength dependent), the loss of any DCM present, the adjustable loss of the VOA and the loss of the span transmission fiber respectively. In the typical system design each EDFA (including all components within the EDFA device module) produces about enough gain to overcome the preceding span loss, so that Eq. 3 evaluates to about 0 for each span. Eq. 3 shows how the VOA loss is used to compensate for variations in span loss, DCM loss and passive losses. Because the DCM and VOA are typically within the EDFA, the measured gain of the amplifier unit is rewritten:

Gₐₘₚ(λ,Īnv,l)=[(g*(λ)+α(λ))Īnv−α(λ)]l−Lₚₐₛₛ(λ)−L_{VOA}(λ)−L_{DCM}(λ)≈Lₛₚₐₙ(λ) (4)

or, in analogy to Eq. 2:

[Gₐₘₚ(λ,Īnv,l)−Lₚₐₛₛ(λ)−L_{VOA}(λ)−L_{DCM}(λ)]/l=[(g*(λ)+α(λ))Īnv−α(λ)] (5)

For the gain shape to remain constant in a broadband WDM optical system, the average inversion must remain constant, which is equivalent to saying that the losses on the left side of the expression must be held constant. This is the role of the VOA in FIGS. 6 and 7. For the EDFA gain to be flat at a given operating point, a filter element must be added to flatten the appropriate spectrum. This is the role of the gain-flattening filter (GFF) in FIGS. 6 and 7. When a VOA and GFF are both present, flatness (to some accuracy over a wavelength range) can be maintained for a range of optical gain levels. For purposes of the present invention the most nearly flat gain condition is defined as the condition that achieves the minimum value of the difference between the maximum gain and minimum gain for any wavelength within a particular bandwidth or wavelength range.

The limitations on the dynamic range achieved by this approach are twofold. First of all, the full range of attenuation achievable by many VOAs is limited to about 20 dB, especially when it is required that the VOA produce the same loss over a wide range of wavelengths. However, even if the VOA had a wider attenuation range, a second limitation is created by the performance of the EDFA itself. Usually, beyond 10 dB of VOA loss, and almost always when 15 dB of loss is added, the NF performance and/or power output of an EDFA are severely degraded. The VOA dynamic range is used to accommodate variations in passive losses, DCM losses and to produce a range of amplifier gain levels. Hence, the dynamic range of an EDFA using the current approach is less than the VOA dynamic range. For example, for a typical EDFA as shown in FIG. 6, a 15 dB VOA loss might accommodate 10 dB of DCM loss variation (DCMs ranging from 2 to 12 dB) and 2 dB of passive component variation in EDFA builds, leaving only 3 dB for amplifier flat gain dynamic range. Similarly, for the design of FIG. 7, the VOA might adjust for 2 dB of passive component variation, leaving an amplifier dynamic range of about 13 dB. Currently, commercially available EDFAs with VOAs and DCMs have less that 5 dB of dynamic range while EDFAs without DCMs are limited to 15 dB of dynamic range.

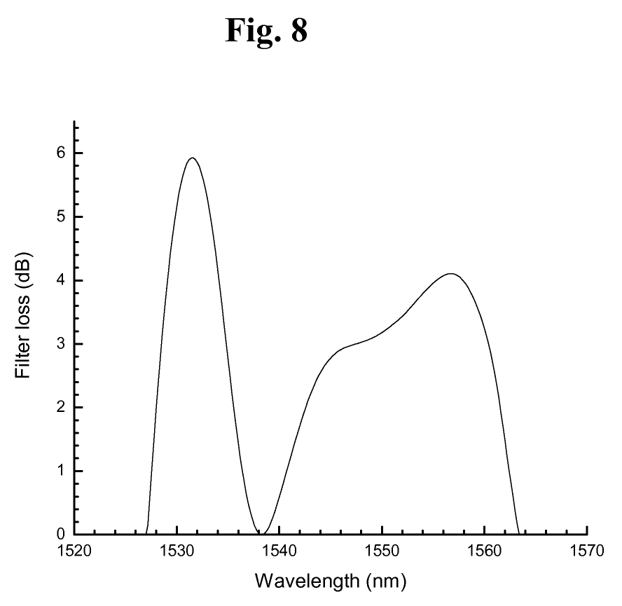

It is useful to go through a simple design calculation to illustrate the limitations of this approach. Assuming the design of FIG. 6, with a total of 3 dB passive loss for all in-line components other than the filter and VOA, we can design an EDFA to achieve a maximum of 26 dB flat gain to compensate for a 26 dB span loss. If we assume that the MSA loss can be 2-12 dB, as suggested above, the total gain that the EDF itself must produce is 26+3+12=41 dB (assuming that the VOA is set to 0 dB for 12 dB DCM loss). If we want the EDFA to operate from 1529-1563 nm with 0.66 average inversion, then we require 26.1 m of total EDF (of the type with parameters shown in FIG. 1), split between the stages. The split between the stages as well as the pump power and configuration determine the NF and efficiency of the EDFA, but not the spectrum, as long as the average inversion is achieved. The filter required is then easily calculated by using a rearranged version of Eq. 5, and is shown in FIG. 8. It is then possible to compute the operating condition for a range of cases. These are shown in table 1 below. In all cases, the EDF produces 41 dB of gain and a 0.66 inversion, but the VOA setting and changes in components account for the change in EDFA module gain. As can be seen, the full dynamic range of a 15 dB VOA is used up in producing a 5 dB EDFA dynamic range. Furthermore, placing more than 18 dB of loss between stages 1 and 2 of an EDFA produces a significant NF impact.

TABLE 1
Design operation for EDFA as in FIG. 6.

| | | | |
|---|---|---|---|
| | | VOA | Total loss |
| EDFA gain | DCM loss | setting | Stages 1-2 |

| | | | | | |
|---|---|---|---|---|---|
| 26 dB | 12 | dB | 0 | dB | 13 dB |
| 26 dB | 2 | dB | 10 | dB | 13 dB |
| 23 dB | 12 | dB | 3 | dB | 16 dB |
| 23 dB | 2 | dB | 13 | dB | 16 dB |
| 21 dB | 2 | dB | 15 | dB | 18 dB |

The NF penalty produced by placing loss between stages of amplification in an EDFA is easily explained by realizing that an EDFA produces spontaneous emission (SE) that is amplified to become amplified spontaneous emission (ASE) through the amplifier. SE produced at each point in the amplifier travels through the following gain and increases the ASE at the output. The signal travels through all gain and loss while part of the ASE is generated after some gain or loss. So, the more loss at the front of the EDFA, the more disadvantage the signal encounters and the worse the NF. The NF can be mathematically represented (in dB units) by:

$$NF ( {λ}_{S} ) = 10 log 10 [ \frac{1}{g ( {λ}_{s} )} + \frac{{P}_{ase} ( {λ}_{s} )}{g ( {λ}_{s} ) {hv}_{s} {B}_{o}} ] \qquad ( 6 )$$

where g(λₛ) is the amplifier gain expressed in linear units, Pₐₛₑ(λₛ) is the output ASE within optical bandwidth B₀ and vₛ is the frequency of signal light. The first term is signal shot noise and is usually small compared with the second term, the signal-ASE beat noise. If multiple stages of amplification produce gains gᵢ and noise figures nfᵢ and are interleaved with losses lᵢ, the total EDFA noise figure (in linear units) can be approximated (neglecting the small shot noise term) by:

$${nf}_{tot} = {l}_{o} {nf}_{1} + \frac{{l}_{o} {l}_{1}}{{g}_{1}} {nf}_{2} + … \frac{{l}_{o} {l}_{1} … {l}_{n - 1}}{{g}_{1} {g}_{2} … {g}_{n - 1}} {nf}_{n} \qquad ( 7 )$$

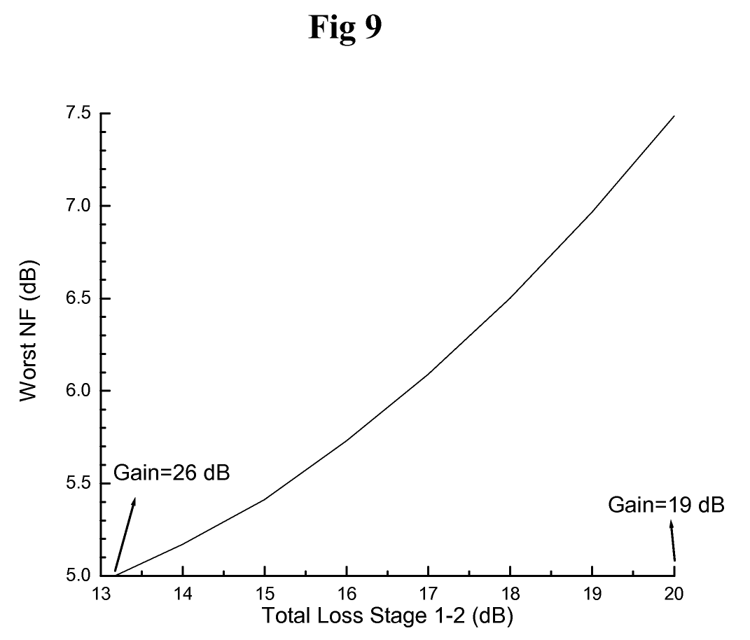

The NF of stage 1 normally dominates this expression, but as the loss between stages 1 and 2, l₁ approaches the gain of stage 1 g₁, the overall NF begins to include contributions from the second stage. Similarly, other stages can contribute to the NF if the gain experienced before entering the stage becomes small. As an example, for the case described above, a three stage EDFA was modeled with 26 dB of maximum gain and all the conditions described above. The NF of the worst wavelength across the band was simulated and is plotted as a function of mid-stage loss in FIG. 9. As the EDFA gain is reduced by increasing the VOA loss, the NF rises and rapidly penalizes transmission through a communication system. At some level of loss, the NF becomes unacceptable for error-free transmission.

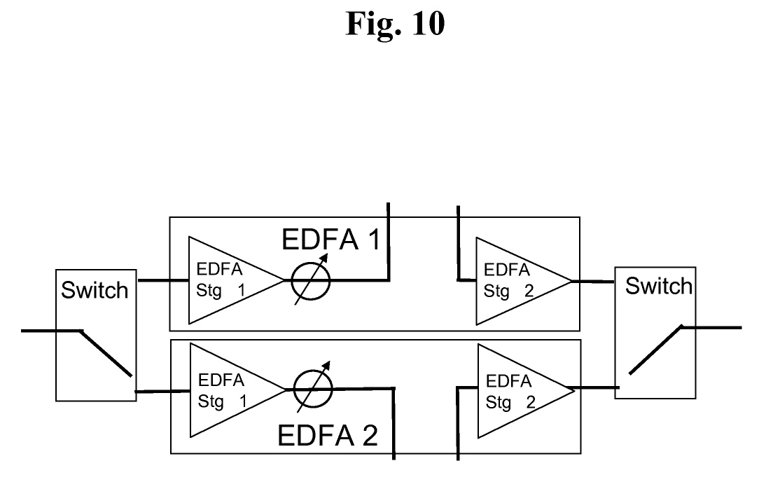

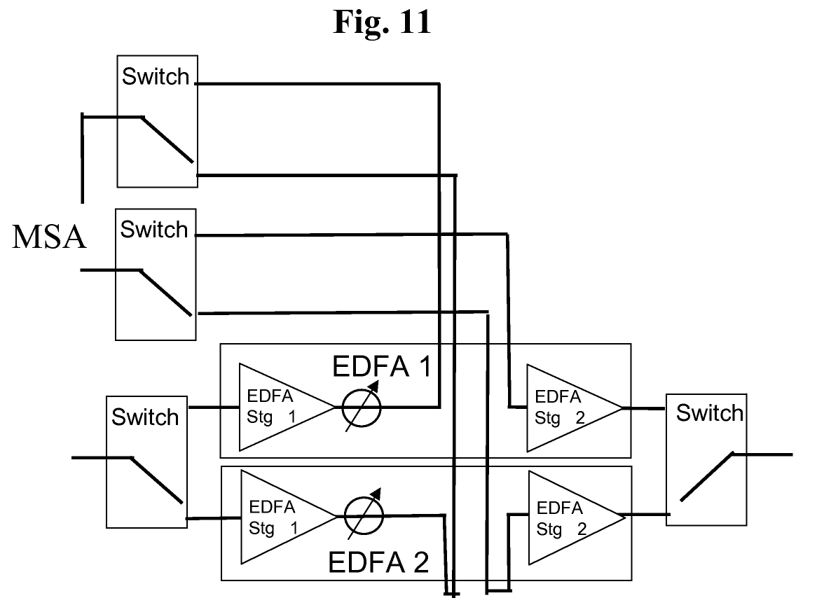

To produce an EDFA with a greater dynamic range, it is possible to design multiple EDFAs with different flat gain ranges and then switch between them, as shown in FIG. 10. Such an approach has to our knowledge never previously been disclosed. It is important to realize that the different EDFAs in FIG. 10 operate in the same wavelength range, but only one has signals present at a selected time. This is in distinction to previously disclosed EDFAs that are preceded and followed by wavelength band splitting components. Such designs amplify each wavelength band separately and simultaneously in different EDFAs. There are several problems with the approach of FIG. 10. The first obvious problem is that it does not allow for a single MSA. FIG. 10 shows 2 different MSA points for the 2 EDFAs, which is generally not an acceptable approach. One way to solve this problem is depicted in FIG. 11. Switches can be added to the design of FIG. 10 to switch the MSA along with the EDFA inputs and outputs. Clearly, the design of FIG. 10, and even more so FIG. 11, is an expensive and complex way to make a wideband EDFA, requiring duplication of many components. The second issue with the approach is that the optical loss of the switches is split between the input of the amplifiers where it greatly impacts the NF and the output of the amplifiers where it greatly impact the efficiency and output power.

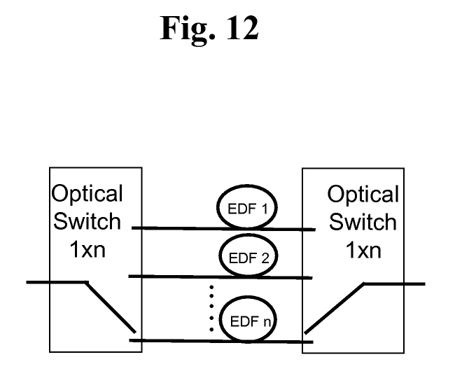

Another new and better approach disclosed here for producing a wide dynamic range EDFA is based on a unique understanding of Eqs. 3-5. The simple addition of EDF anywhere in an EDFA can be used to shift the average gain at which flatness is achieved. As noted above, any EDFA operating at a given average inversion has the same gain shape. Two EDFAs operating with the same average inversion but containing different fiber lengths have the same gain shape, but total gain scaled by the length of the fiber. So, one way to make an EDFA operate with a flat gain at 2 gain levels is to add or subtract EDF based on the desired operating gain. One configuration that can be used within an EDFA to accomplish this task is shown in FIG. 12. This device is called a dynamic range enhancer (DRE) throughout this document. In the DRE, two 1×n switches are configured to switch between n different lengths of EDF. It should be noted that one of the EDF lengths could be 0. By careful choice of these lengths, the device of FIG. 12 operates as a dynamic range selector to create a wide dynamic range EDFA. The number of paths n through the device depends on the dynamic range of the desired EDFA and the accuracy with which each gain must achieve flatness. It should be noted that the DRE of FIG. 12 does not contain any pump power. If properly located within an EDFA, the presence of unpumped EDF has little impact on output power or NF but does contribute to changes in gain spectrum. Eq. 3-5 hold true regardless of whether some EDF segments are unpumped. Some numerical examples will be discussed below.

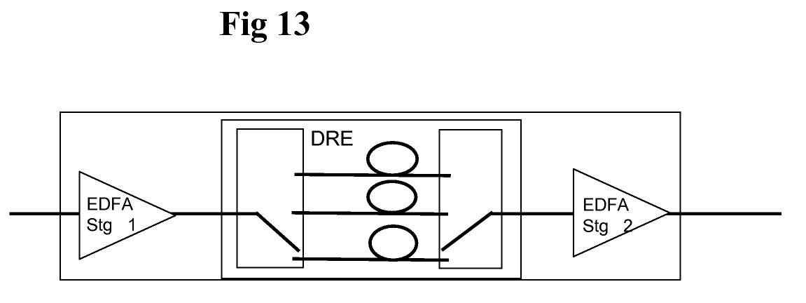

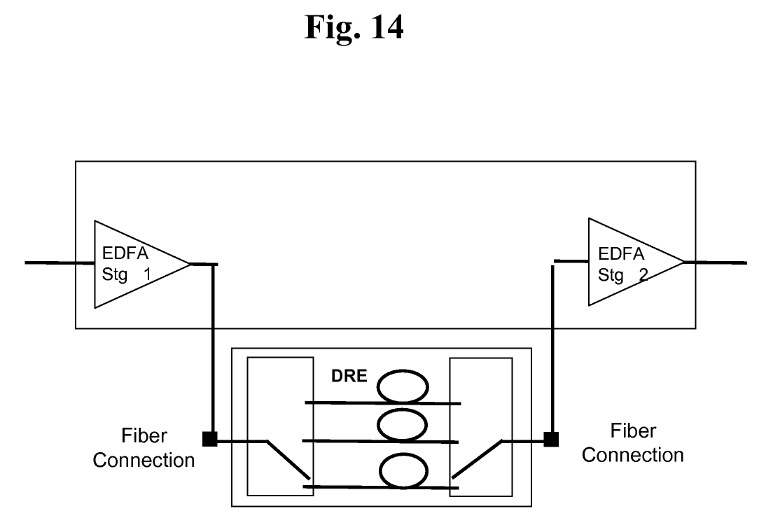

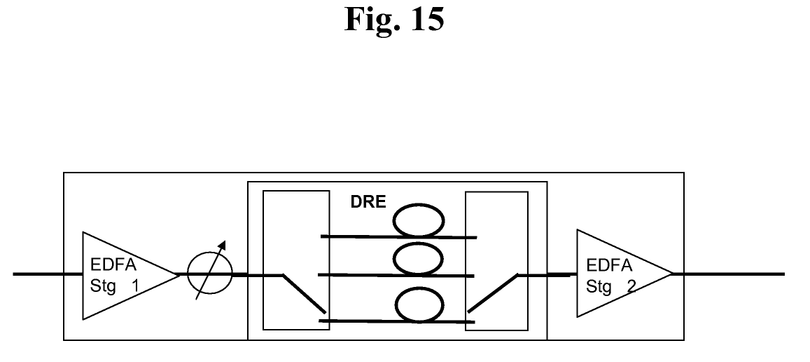

The use of the DRE in an EDFA without a VOA is shown in FIG. 13. In this design, the EDFA is able to achieve a wide dynamic range without the presence of a VOA. It should also be noted that there is nothing unique about the particular configuration shown in FIG. 12. The DRE can be used within an EDFA with any number of stages, between any particular stages. It can be placed at the input end of the EDFA, although a NF penalty would result. It could also be placed at the output of the EDFA, although a power penalty would result. As long as the DRE provides multiple paths with different EDF lengths, it can serve as a dynamic range enhancer. The DRE can be inserted within the same package as the EDFA stages, or it can be connected in series at the input or output or at the MSA. The placement of the DRE at the MSA is depicted in FIG. 14. The DRE can also be used to achieve an even wider dynamic range by combining it with a VOA inside an EDFA, as shown in FIG. 15. In this configuration, the path selection in the DRE is used as a course adjustment to the operating range and the VOA provides fine adjustment for the flatness at the operating gain point. For example, each path of the DRE could be used for a 5 dB gain range selected by the DRE switches, and the VOA could be adjusted from 0 to 5 dB of loss within each range.

The simplest way to describe the design of the DRE EDF lengths is by an example. First assume that we desire to make an EDFA covering 1528-1563 nm with a 10-30 dB dynamic range without a VOA and that there is a total of 5 dB of total passive loss inside the EDF. Further assume that we want to cover the entire range with a 4 path DRE, 1 path each for 10-15 dB, 15-20 dB, 20-25 dB and 25-30 dB. The middle of each of these ranges is 12.5, 17.5, 22.5 and 27.5 dB, respectively. Then, Eq. 4 rewritten shows that we must add in the passive losses to the amplifier gain:

Gₐₘₚ(λ,Īnv,l)+Lₜₒₜ(λ)=[(g*(λ)+α(λ))Īnv−α(λ)]l (8)

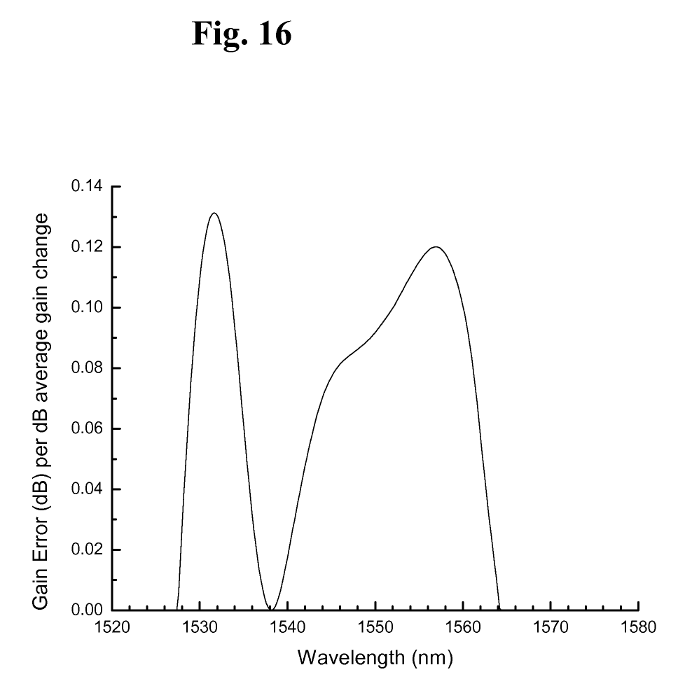

Adding the passive loss, each range must then accommodate 17.5, 22.5, 27.5 and 32.5 dB of EDF gain respectively. Assuming a 0.65 inversion in all cases for the EDF of FIGS. 1 and 2, this leads to the need for 11.75, 15.11, 18.47, and 21.83 m of total EDF in each path. We might then choose to place the shortest length, 11.75 m in the EDFA stages themselves and set the path 1 EDF length to 0. The main EDFA filter might then be designed to filter perfectly the lowest gain case with 0.65 inversion and 11.75 m. Then, the other paths should contain the difference lengths, or 3.36, 6.72 and 10.08 m of EDF respectively. All, other paths, when selected would then operate at 0.65 inversion at the nominal gain and would be reasonably flat. However, the scaling of the gain shape with length implies some gain shape error per dB of additional gain. The amount and shape of gain ripple produced per dB of additional gain by this approach is shown in FIG. 16. This shape is just the top of the 0.65 inversion plot of FIG. 3 filtered to the design wavelength range and scaled to 1 dB average gain. So, since each range in this example produces 5 dB more gain than the previous range, the ripple increases by 5× the value in FIG. 16 for each range selected.

This example has not illustrated clearly the generality of the DRE design process. While it was assumed that the EDFA and DRE were both designed to the same inversion, this is not necessary. The example DRE, when designed to operate with inversion 0.65, would work inside an EDFA designed to operate at a different average inversion and would produce the same ripple result. The same DRE could be placed within different EDFAs designed for different gain levels and still perform its function. This is hard to derive from theory but has been confirmed by modeling a large set of cases. The only requirements for the DRE to work as designed is for the overall gain of the EDFA with internal DRE to be as designed. This requires proper adjustment of pump power as each range is selected. The same approach can be used for different wavelength ranges, or even for a much lower inversion in the L-band. It could even be used in other fiber amplifiers in other band as long as gain saturation is present.

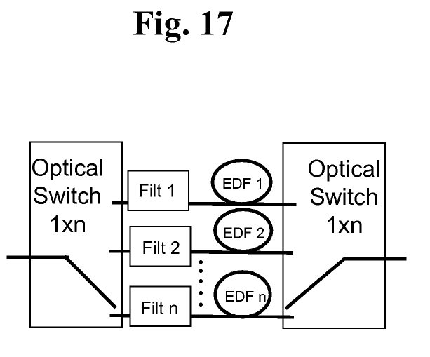

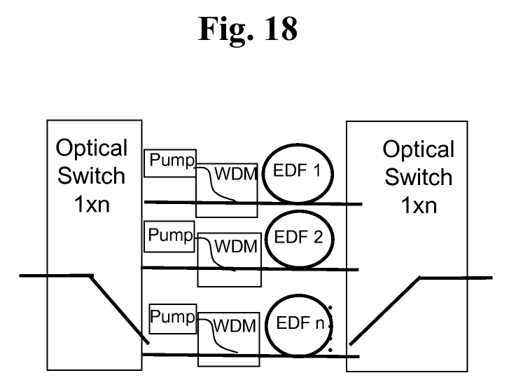

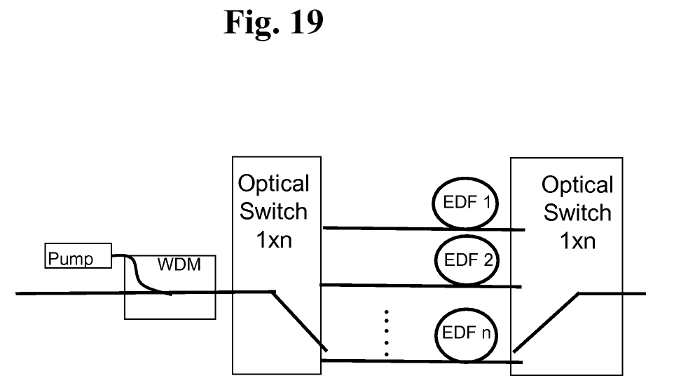

Further enhancements to the DRE are possible. In particular, to eliminate the ripple, each path in the DRE can be separately filtered with small magnitude filters (often called clean-up filters). This configuration is shown in FIG. 17. One particular or several of the paths could be chosen to contain no filter at all. Furthermore, nothing about the design done here presupposed the presence or absence of a pump to provide gain in the EDF lengths within the DRE. A pump in the DRE could be provided to improve noise or power output from the overall EDFA. 2 such pumped DREs are shown in FIGS. 18 and 19. In FIG. 18, separate pumps are provided in each DRE EDF length while in FIG. 19, a pump is provided through the switch at one DRE end to whichever path is selected at a given time. The implication in FIG. 19 is that both the pump and the signal pass through the switch with little loss. This switch must be properly designed or selected to serve this unique role. A pump for the DRE could also be leftover pump power coming from a stage of the EDFA itself. It should be noted that all paths do not need to receive the same pump treatment or the same magnitude of pump power. Some paths can be unpumped while others are pumped. A pump can be provided in the opposite direction or in both directions, as is well known in the field. It should also be recognized that other passive components could be placed within the DRE without changing materially the intent of the device. For example, optical isolators might be useful to suppress ASE or other filters might be present for the same purpose.

When used together with a VOA, the DRE can provide an EDFA dynamic range far exceeding that of other EDFAs. The cost of the device and simplicity make it desirable in comparison with the design of FIG. 10. But, the advantage of the DRE is also in improving NF performance, even for the same dynamic range device. The improvement flows from the realization that loss provided by a VOA always reduces signal power and is therefore a source of NF degradation. On the other hand, unpumped EDF in a DRE allows large signals to pass with very little loss, due to the saturation behavior of the EDF. Furthermore, in pumped DREs, the EDF provides gain that can reduce the noise contribution of following stages.

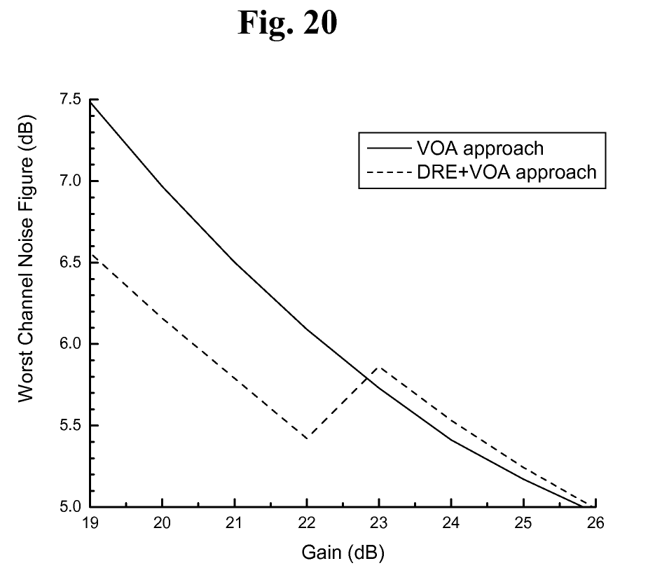

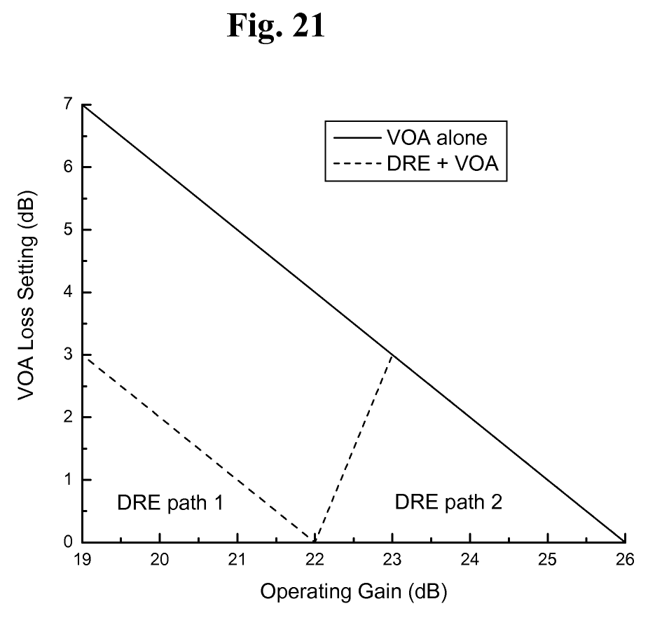

To illustrate the advantages of the DRE approach, a simulation was run consistent with the 26 dB EDFA design of FIG. 9, but using a 2 path DRE. One path contained no components while the other contained 3 m of EDF, to roughly accommodate a 4 dB gain change. The EDFA operated from 22 dB to 26 dB of gain with the path selected to have 3 m of extra EDF and from 18 dB to 22 dB of gain with the path selected to have no extra EDF. This DRE was placed immediately preceeding the VOA, which then only was adjusted from 0 to 4 dB of loss (In addition to 13 dB of total DCM+component midstage loss). The resultant NF of the worst channel in the VOA and DRE+VOA cases is shown in FIG. 20. While the NF is slightly worse for the DRE for high gain operation, at low gain operation, the DRE allows for a nearly 1 dB NF improvement. FIG. 21 shows the operation loss of the VOA in both design cases. Because the inclusion of the DRE reduces the loss of the VOA, it improves noise performance.

One important variation to note about the use of the DRE is that it is possible to use it in systems that contain amplifiers other than EDFAs, or systems that include multiple amplification media. For example, some transmission systems currently utilize amplification via stimulated Raman scattering to enhance system performance in conjunction with EDFAs. The DRE described here can be used in conjunction with such systems as long as the system includes an EDFA as an in-line amplifier. Additionally, as described above, the general approach is applicable to other fiber gain media.

It should also be noted that the description of this device does not preclude the use of this approach for optical waveguides that are not in fiber form. Erbium-doped waveguide amplifiers are well known and can be designed to operate as dynamic range enhancers. The potential exists for integrating different waveguide lengths, filters or other devices between two switches as described herein to make a DRE in a compact waveguide format.

1. A multi-channel optical amplifier arrangement operating over a particular bandwidth, comprising:
at least one optical amplifier stage that includes a rare-earth doped optical waveguide, at least one pump source for supplying optical pump energy to the doped optical waveguide, and at least one coupler for coupling the optical pump energy to the doped optical waveguide;
a dynamic range enhancer (DRE) having an input and an output and a plurality of distinct optical paths each selectively coupling the input to the output, at least two of said optical paths producing different gain spectra across the particular operating bandwidth, said DRE further including an optical path selector for selecting any optical path from among the plurality of optical paths such that for all channels in the particular bandwidth the selected path optically couples the input to the output of the DRE;
wherein an input or output of the optical amplifier stage is optically coupled to the output or the input, respectively, of the DRE.

2. The optical amplifier arrangement of claim 1 wherein at least one of said optical paths is doped with a rare-earth doped optical element

3. The optical amplifier arrangement of claim 1 wherein said DRE is a modular unit selectively removable from and optically couple-able to the optical amplifier stage.

4. The optical amplifier arrangement of claim 1 wherein when each distinct path of the DRE is selected and an operating condition of the amplifier arrangement is adjusted to produce a most nearly flat gain condition, the magnitude of the gain achieved is different for at least two of the distinct paths, wherein the most nearly flat gain condition is defined as the condition that achieves the minimum value of the difference between the maximum gain and minimum gain for any wavelength within the particular bandwidth.

5. The optical amplifier arrangement of claim 1 wherein said DRE is a modular unit selectively removable from and optically couplable to the optical amplifier stage.

6. The optical amplifier arrangement of claim 1 wherein said plurality of distinct optical paths comprise N optical paths, N being an integer equal to or greater than 2, and said optical path selector includes first and second 1×N optical switches for selectively switching among the N optical paths.

7. The optical amplifier arrangement of claim 1 wherein said at least one optical amplifier stage includes at least first and second optical amplifier stages.

8. The optical amplifier arrangement of claim 7 wherein the input of the DRE is coupled to an output of the first optical amplifier stage and the output of the DRE is coupled to the input of the second optical amplifier stage.

9. The optical amplifier arrangement of claim 7 wherein said DRE is located at a midstage access (MSA) connection port to the optical amplifier arrangement, said MSA connection port being located between any two optical amplifier stages.

10. The optical amplifier arrangement of claim 1 further comprising a variable optical attenuator optically coupled to at least the optical amplifier stage or the DRE.

11. The optical amplifier arrangement of claim 2 further comprising at least one pump source for supplying optical pump energy to the rare-earth doped optical path of the DRE.

12. The optical amplifier arrangement of claim 1 wherein said doped optical waveguide is a doped optical fiber.

13. The optical amplifier arrangement of claim 1 wherein said doped optical waveguide is a doped planar waveguide.

14. The optical amplifier arrangement of claim 1 wherein said doped optical waveguide is doped with erbium.

15. The optical amplifier arrangement of claim 1 wherein said each of said optical paths comprises an optical fiber.

16. The optical amplifier arrangement of claim 1 wherein said each of said optical paths comprises an optical planar waveguide.

17. The optical amplifier arrangement of claim 1 wherein each of said plurality of optical paths is doped with a rare-earth optical element.

18. The optical amplifier arrangement of claim 6 wherein (N−1) of said N optical paths are doped with a rare-earth optical element.

19. The optical amplifier arrangement of claim 1 wherein each of said plurality of optical paths provides a most nearly flat level of gain across an operating band of the optical amplifier stage at a common rare-earth ion inversion level.

20. The optical amplifier arrangement of claim 17 further comprising at least one pump source for supplying optical pump energy to at least two of the rare-earth doped optical paths.

21. The optical amplifier arrangement of claim 1 wherein at least one of said optical paths has at least one element located therein selected from the group that includes an optical filter, a passive optical component, and an adjustable loss element.

22. An apparatus for extending the dynamic range of a multi-channel optical amplifier operating over a particular bandwidth, comprising:
an input and an output;
a plurality of distinct optical paths each selectively coupling the input to the output, at least two of said optical paths producing different gain spectra across the particular operating bandwidth, at least one of the optical paths including a rare-earth doped optical element;
an optical path selector for selecting any optical path from among the plurality of optical paths such that for all channels in the particular bandwidth the selected path optically couples the input to the output;
wherein an input or output of the optical amplifier stage is optically coupled to the output or the input, respectively, of the DRE.

23. A method for extending the dynamic range of a multi-channel optical amplifier operating over a particular bandwidth, wherein the dynamic range is defined as the range of gains over which a most nearly flat gain spectrum is achieved, comprising:
receiving an optical signal at an input;
directing the optical signal from the input to a selected one of a plurality of distinct optical paths each selectively optically coupling all channels in the particular bandwidth from the input to an output, at least 2 of said optical paths producing different gain spectra across the particular operating bandwidth, at least one of the optical paths including a rare-earth doped optical element, each of the optical paths have the characteristic that produces, when coupled with the optical amplifier stage, a combined gain spectrum of the optical amplifier over the particular bandwidth that would be most nearly flat at a different gain; and
optically coupling an input or output of a stage of the optical amplifier to the output or the input, respectively.
